(19) United States
(12) Patent Application Publication
(10) Pub. No.: US 2007/0289208 A1
(43) Pub. Date: Dec. 20, 2007

(54) Landscaping vegetation border unit

(76) Inventor: Yos Soetanto Theosabrata, Jakarta (ID)

Correspondence Address: SANDRA LEE LIPKIN;A LAW CORPORATION, 1891 GOODYEAR AVE., SUITE 622, VENTURA, CA, 93003, US

(21) Appl. No.: 11/449,522

(22) Filed: Jun. 7, 2006

(51) Int. Cl. A01G 1/08

(52) U.S. Cl. 47/33

(57) ABSTRACT

A landscaping vegetation border unit that is elongated and is formed by a pair of spaced apart sidewalls and a bottom wall which has an open top. The unit defines an internal compartment. Each of the sidewalls are divided by a series of transverse slots that form each of the sidewalls into a plurality of separate panels. The bottom wall includes an adjustment means that will permit the sidewalls to be bent. The soil and growable vegetation is to be placed within the internal compartment with the border units to then be used to separate to divide separate cement sections in a landscape environment.

### BACKGROUND OF THE INVENTION

1. Field of the Invention

The subject matter of this invention is directed to the constructing of an elongated border unit that is to include vegetation with this unit being utilized to ornately divide different directly adjacent sections of cement in a landscaping environment.

2. Description of the Related Art

Cement is commonly used to produce driveways, patios and walkways. To merely make a driveway, walkway or patio as a continuous cement structure, to many people, does not constitute a particularly attractive appearance. Some people would prefer to break up the cement structure into different sections with the peripheral edge of these different sections not necessarily being straight but having some arcuate configuration. This arcuate configuration can produce a more attractive appearance.

In the past, there have been attempts to break up sections of cement. To make such more attractive, bricks have commonly been used. However, bricks generally require the producing of straight peripheral edges for the cement. There has also been used wood, commonly referred to as benderboard and this benderboard is capable of being bent to assume a curved configuration which will produce curved peripheral edges for the cement.

In the past, it has also been common to form grass sections between the sections of cement. Generally, these grass sections are one to three feet across and have the function of producing a significantly more attractive appearance for the cement driveway, walkway or patio. Usually, when the cement is poured, there is formed within the driveway, walkway or patio forms that are to be used to define the area that is to be grass which is to be thereupon planted after the cement has been poured.

### SUMMARY OF THE INVENTION

It would be desirable to design a structural unit that can be utilized within the defined area of a driveway, walkway or patio that will not only divide the cement structure into a plurality of different cement sections with the unit to function as a form to prevent the fresh cement from penetrating past a certain area but also where the unit can include vegetation which will produce an attractive appearance by dividing the cement section into a plurality of different sections. The structural unit also function as a form to comprise a barrier for the cement as it is poured.

The generic embodiment of the present invention is directed to constructing a landscaping elongated vegetation border unit formed of a sheet material planar housing having an internal compartment formed by a pair of spaced apart sidewalls and a bottom wall and an open top which has an access opening. Each of the sidewalls are divided into a plurality of panels with there being an air gap formed by a transverse slot between each directly adjacent panels. The housing is capable of being laterally bent to assume a generally curved shape which will cause each of the slots on one sidewall to be widened and on the opposite sidewall to cause the panels to slidingly overlap each other. A bottom wall includes an adjustment means that permits the sidewalls to be laterally bent. Whereby the internal compartment can be filled with a soil and a vegetation that is to grow and completely fill the access opening and then the housing can be used to divide separate cement sections in a landscape environment.

A further embodiment of the present invention is where the generic embodiment is modified by defining that the sidewalls are evenly spaced apart.

A further embodiment of the present invention is where the generic embodiment is modified by defining a first embodiment where the bottom wall includes a plurality of overlapping flaps with there being a series of these overlapping flaps mounted at a ninety degree displaced position relative to one sidewall and another series of these flaps is mounted a ninety degree displaced position relative to the other sidewall.

A further embodiment of the present invention is where the generic embodiment is modified forming a second embodiment defining that the adjustment means comprises a series of narrowed frangible strips that are breakable in order to divide each strip of the strips into two sections that can overlap which will occur when bending of the sidewalls to an arcuate configuration.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is a cement structure, such as would be commonly found within a driveway, walkway or patio showing usage of a plurality of a landscaping elongated vegetation border units of the present invention being used to divide the cement structure into a plurality of different cement sections;

FIG. 2 is a side elevational view of one of the landscaping elongated vegetation border units of the first embodiment of the present invention that is intended to be constructed of cardboard;

FIG. 3 is an isometric view of one of the landscaping elongated vegetation border units of the first embodiment of the present invention showing the unit in a curved (arcuate) configuration;

FIG. 4 is a view similar to FIG. 3 but where the end of the border unit is closed in order to contain the soil that is contained within the internal compartment of the border unit;

FIG. 5 is a transverse cross-sectional view taken along line 5-5 of FIG. 1;

FIG. 6 is a view similar to FIG. 5 but of a second embodiment of a landscaping elongated vegetation border unit of the present invention that is intended to be constructed of a plastic material;

FIG. 7 is a side elevational view of the second embodiment of the landscaping elongated vegetation border unit of the present invention;

FIG. 8 is a top plan view taken along line 8-8 of FIG. 7 of the second embodiment of landscaping elongated vegetation border unit of the present invention; and

FIG. 9 is a view similar to FIG. 8 but showing the border unit in a curved (arcuate) configuration.

### DETAILED DESCRIPTION OF THE INVENTION

Referring particularly to FIG. 1, there is a shown a landscaping area 10 which is composed of a plurality of spaced apart cement sections 12. The cement sections 12 are separated by a border unit 14. It is seen in FIG. 1 that the border units can be curved to be almost semicircular. It is considered to be within the scope of this invention that the border units could be straight or could be curved other than semicircular or could be curved like an S-shape with such curving being strictly the decision of the installer.

When pouring of the cement sections 12, the border units 14 are placed in the desired position. The cement sections 12 are then poured between the border units with the border units functioning as a form to provide a barrier to prevent flow of the cement past a certain location. The height of the border units 14 are selected to the desired thickness of the cement sections 12. Typically, the border units 14 will be four to six inches in height.

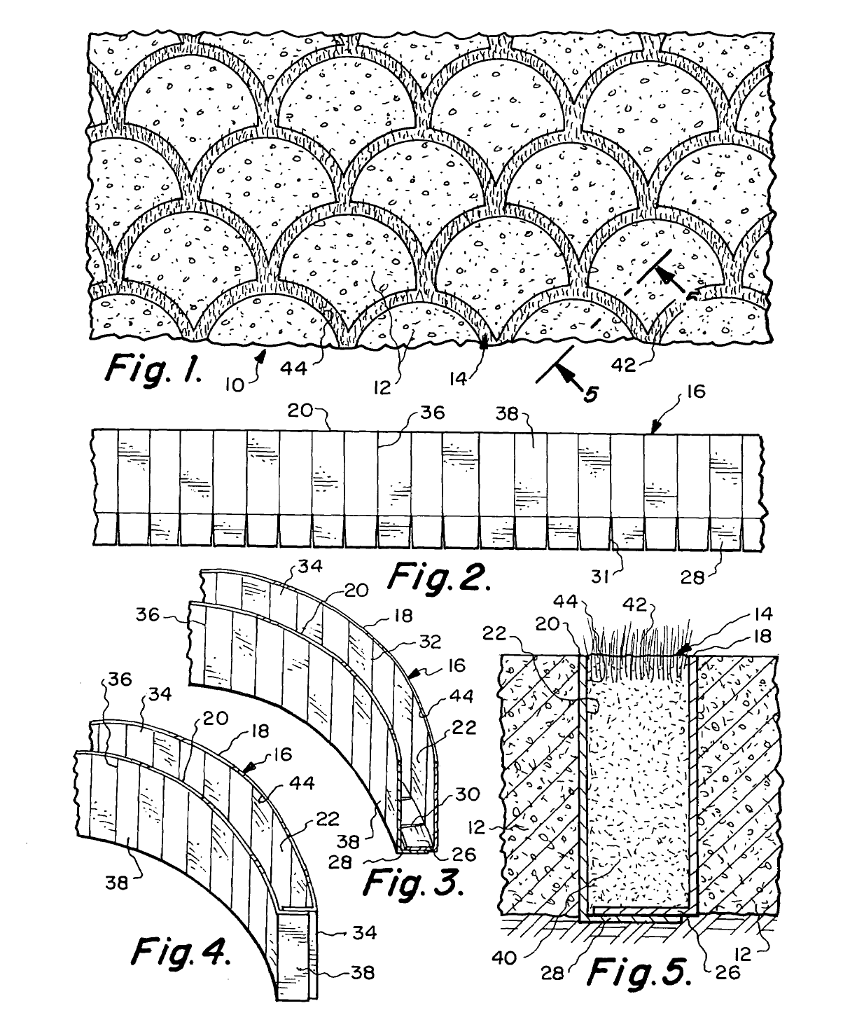

Referring particularly to FIGS. 1-5 of the drawings, there is shown the first embodiment of border unit which is constructed of a housing 16 constructed of cardboard and formed of a pair of evenly spaced apart sidewalls 18 and 20. A gap area is formed between the sidewalls 18 and 20 which is defined as the internal compartment 22. Internal compartment 22 is closed by a bottom wall which is formed by a section of flaps 26 which are integrally attached to the sidewall 18 and are located at right angles thereto and a series of flaps 28 which are integrally attached to the sidewall 20 and extending at a right angle therefrom. The flaps 26 and 28 are a placed on top of each other. There is to be located a series of the flaps 26 each generally no more than an inch to one inch and a half in length with there being located a slot 30 between the directly adjacent flaps 26. The flaps 28 are similarly constructed with also having a slot 31, located between directly adjacent flaps 28. It is considered to be within the scope of this invention that the first embodiment could be constructed of sheet material other than cardboard. Typical thickness will be around one-eighth of an inch.

The sidewall 18 includes a series of longitudinal slots 32 which essentially divide the sidewall 18 into a section of similarly sized panels 34. In a similar manner, the sidewall 20 includes a series of longitudinal slots 36 with there being a slot 36 to be located each directly adjacent pair of panels 38 which form the sidewall 20. Typically, the panels 38 will all be the same width and will be probably identical in width to the panels 34. Because of the utilizing of the slots 30, 31, 32 and 36, the housing 16 can be manually deformed into an arcuate configuration. When this deformation takes place, in the outer wall of the curve the slots 32 will actually widen. Where in the inner wall of the curve, the slots 36 will actually narrow and in all probability the panels 38 slightly overlap each other. In most instances, it will be desirable to close off the ends of the internal compartment 22. This can be accomplished by merely folding inward a pair of the panels 34 and 38, as shown in FIG. 4 with these panels 34 and 38 abutting each other. It is to be understood that both ends of the border unit will be closed in the manner as is shown in FIG. 4. Typically, a border unit will be two to three feet in length. When curing of the border unit the flaps 26 and 28 will slidingly overlap.

The internal compartment 22 is intended to be filled with a soil 40. Within the upper layer of the soil 40 is to be planted vegetation 42. The upper or top end of the internal compartment 22 has an access opening 44. This access opening 44 is intended to be completely covered by the vegetation 42. It is the vegetation 42 that provides the desirable appearance separating each of the concrete sections 12. Typical vegetation will be grass.

It is to be understood that the soil 40 could comprise dirt, mulch or any other type of growable medium. Vegetation 42 could be grass, dichondra or any other type of low height growing vegetation.

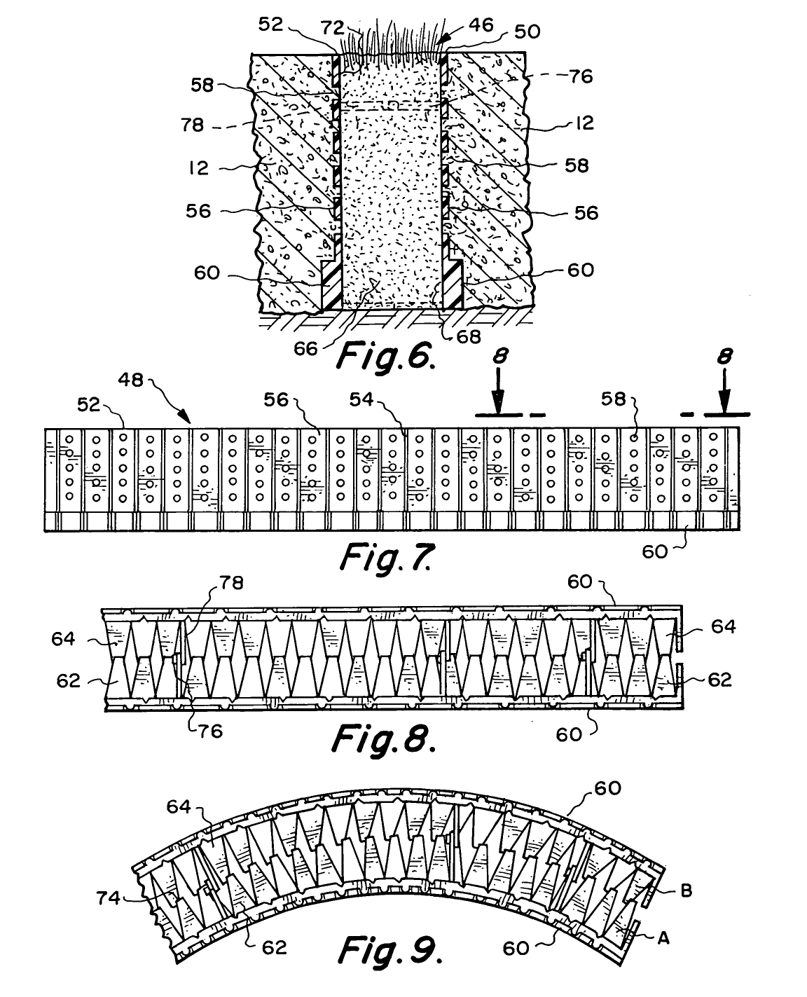

Referring particularly to FIGS. 6-9 of the drawings, there is shown a second embodiment of border unit 46 of this invention. The second embodiment 46 will have a housing 48 that is constructed of a plastic material. The housing 48 is formed of evenly spaced apart sidewalls 50 and 52 which will normally be spaced apart two to four inches. Both the sidewalls 50 and 52 include a series of evenly spaced apart longitudinal slots 54 with the slots 54 functioning to divide the sidewalls 50 and 52 into a series of panels 56. Panels 56 are typically the same width within each of the sidewalls 50 and 52. Each of the panels 56 include a series of holes 58. The holes 58 are to function to permit a small portion of the cement, when pouring of the cement sections 12, to enter within each of the holes 58 to provide a securement that will permanently secure in position the second embodiment of border unit 46 between the cement sections 12. Typically, the panels 56 will be about one to one and one-half inches wide.

The lower end of each of the panels 56 is integrally connected to a base 60 which extends laterally outwardly relative to the panels 56. This base 60 also functions to lock the second embodiment of border unit 46 in position in conjunction with the cement sections 12. In between the bases 60 of the different sidewalls 50 and 52 in the area of the bottom are formed a series of hourglass shaped members 62. These members 62 have a narrowed center 64. The second embodiment 46 of border unit is to be purchased by the consumer containing the soil 66 within the confines of the internal compartment 68 formed between the sidewalls 50 and 52. Vegetation 70 will be permitted to grown within the soil 66 and protrude from the access opening 72 above the upper level of the cement sections 12. In order for the user to bend the second embodiment 46 of border unit of this invention, the user must initially sever each of the members 62 at the narrowed center 64. This severing will produce a break 74. This severing can be accomplished by use of scissors, knife or other type of cutting tool. This will permit the second embodiment 46 to be laterally flexed into an arcuate configuration, as is represented when looking at FIG. 9 relative to the straight configuration shown in FIG. 8. Integrally connected to the sidewall 50 and located within the confines of the internal compartment 68 is a locking member 76. A similar locking member 78 is integrally connected to the sidewall 52 and is also located within the confines of the internal compartment 68. The locking members 76 and 78 are to interlock with each other. It is the function of the locking members 76 and 78 to prevent the sidewalls 50 and 52 from spreading apart from their established position and keep the width of the internal compartment 68 at a preselected value. It is to be understood that similar locking members could be incorporated in conjunction with the first embodiment of border unit 14 of this invention.

When the break 74 has been produced within each of the members 62 and the second embodiment 46 of border unit of this invention is flexed to the current position shown in FIG. 9, the two parts of the members 62 will have a tendency to slightly overlap each other.

The discussion included in this patent is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

What is claimed is:

1. A landscaping vegetation border unit comprising:
a sheet material planar housing having an internal compartment formed by a pair of spaced apart sidewalls, a bottom wall and an open top which has an access opening;
each of sidewalls being divided into a plurality of panels with there being an air gap formed by a transverse slot located between each directly adjacent said panels, said housing being laterally manually bendable so assume a generally curved shape which will cause said slot on one sidewall of said sidewalls to be widened and on the opposite sidewall of said sidewalls to cause said panel to slidingly overlap each other;
said bottom wall including adjustment means that permits said sidewalls to be laterally bent; and
whereby said internal compartment can be filled with soil and vegetation that is to grow and completely fill said access opening and then said housing can be used to divide separate cement sections in a landscaping environment.

2. The landscaping vegetation border unit as defined in claim 1 wherein:
said sidewalls being evenly spaced apart.

3. The landscaping vegetation border unit as defined in claim 1 wherein said adjustment means comprises:
overlapping flaps with there being a series of said flaps attached to each sidewall of said sidewalls with said flaps located at a ninety degree position relative to its respective sidewall.

4. The landscaping vegetation border unit as defined in claim 1 wherein said adjustment means comprises:
a plurality of narrow frangible strips that are breakable dividing each strip of said strips into two sections that can be overlapped when said sidewalls are bent.
